(19) United States
(12) Patent Application Publication
(10) Pub. No.: US 2012/0063840 A1
(43) Pub. Date: Mar. 15, 2012

(54) Friction Ball Joint

(76) Inventor: David C. Yu, Laguna Niguel, CA (US)

(21) Appl. No.: 12/878,907

(22) Filed: Sep. 9, 2010

(51) Int. Cl. F16C 11/06

(52) U.S. Cl. 403/141

(57) ABSTRACT

A friction ball joint and a method for using the friction ball joint are provided. A clam shell is formed from at least two segments. The interior of the clam shell segment, where the ball is in contact, is roughened. The clam shell segments may be interlocked to retain a ball. The surface of the ball is roughened. When the friction ball joint is assembled, the rough surfaces of the ball and the clam shell segments are in contact and resist movement.

### BACKGROUND

1. Field

The present disclosure relates generally to ball joints and their use, and, in particular, to an apparatus and method for a friction ball joint.

2. Background

Ball joints are used in a variety of applications including automotive, medical, and mechanical designs. Typically, ball joints are used in applications or designs where rotational motion is desired. In automotive applications ball joints serve as pivots between the wheels and the automobile's suspension. There, ball joints can act to improve control, stability and tire wear.

Ball joints are found in most linkage systems for motion control applications because they allow rotation in the x, y, and z directions, depending on the design of the ball joint. Motion control ball joints are retained with an internal spring and are examples of the type of ball joints found in linkage systems. Traditional ball joints have a receptacle to hold the ball in place. The ball moves within the receptacle, providing motion in the directions desired. There is an opening in the receptacle to provide interconnection with the device whose motion is to be controlled and directed. This opening in the receptacle limits the amount of vertical rotation possible by the ball's shaft. Horizontal motion is not limited.

Traditional ball joints rotate freely. This free movement means that little force is needed to move the ball joint out of a desired position. A friction ball joint would require a specific amount of force to be applied before movement occurs. No locking mechanism is required, since the friction acts to retain the ball joint in the desired position. There is a need in the art for a friction ball joint.

### SUMMARY

An embodiment provides a friction ball joint. The friction ball joint assembly is formed from a clam shell ball formed from at least two segments. A mechanical element extends from a clam shell segment. The inside surfaces of the clamshell ball, where the ball is placed, are roughened. A ball having a roughened surface is placed between the clam shell segments, in contact with the roughened surface interior of the clam shell segments.

A further embodiment provides a method for using a friction ball joint. The method comprises attaching a first mechanical element extending from a friction ball joint to an object, then attaching a second mechanical element extending from the friction ball joint to a second object. The first object is then positioned in a selected position relative to the second object by moving at least one mechanical element of the friction ball joint. The object is maintained in the selected position by the friction of the roughened surfaces.

Yet a further embodiment provides a positioning apparatus. The apparatus includes means for attaching a first mechanical element extending from a friction ball joint to an object. A means is also provided for attaching a second mechanical element extending from the friction ball joint to a second object. Means is also provided for positioning the first object in a selected position relative to the second by moving at least one mechanical element of the friction ball joint. Means is also provided for maintaining the first object in the selected position using friction. Various aspects and embodiments of the invention are described in further detail below.

### BRIEF DESCRIPTION OF THE DRAWINGS

FIG. 1 is an illustration of a friction ball joint incorporating friction, shown in top, side, and angled views, in accordance with various embodiments of the present invention.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

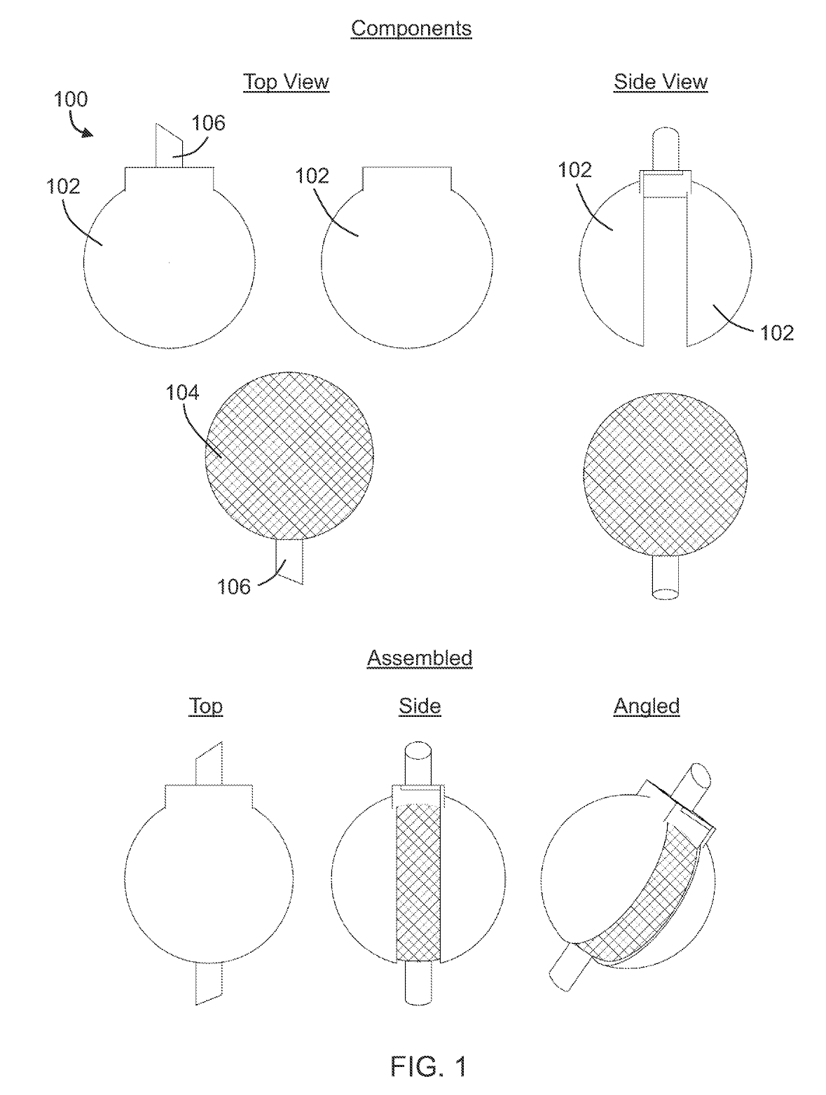

Referring to FIG. 1, a friction ball joint 100, is depicted. The friction ball joint 100 is formed by the clamshell 102, which consists of two pieces that fit together. The inside of each cup of clamshell 102 is roughened. The clamshell pieces 102 may be designed to interlock together so that the force acting between the clamshell 102 sections acts to retain a ball 104 within by exerting force. The surface of ball 104 is roughened and is placed in contact with the roughened interior surface of clamshell 102. A shaft 106 extends from a clamshell 102 segment and also from ball 104. The friction ball joint is not limited to a shaft attachment, rather the friction ball joint may be attached to any surface or connection to an opposite moving component of an assembly or other mechanical element. The shaft 106 may be replaced by any other mechanical interface suitable for attaching the friction ball joint between mechanical devices where movement of the device is desired. FIG. 1 provides unassembled views of the friction ball joint from both top and side view perspectives.

FIG. 1 also provides top, side, and angled views of an assembled friction ball joint according to an embodiment. When assembled, the rough surfaces of the ball and the interior surfaces of clamshell 102 sections are in contact. This contact inhibits the movement of the friction ball joint, enabling the ball joint to be placed in a desired position and remain there until force sufficient to overcome the friction is applied. The angled view illustrates the range of motion provided by the friction ball joint. The amount of friction may be increased by increasing the roughness of the surfaces of both the ball and the clamshell 102 sections. Similarly, decreasing the surface roughness allows more movement.

In operation, the friction ball joint 100 is moved into the desired position by forcing the ball 104 to rotate against the rough surface of the clamshell sections 102. Once in the desired position, the friction ball joint is released and remains in position until sufficient force to overcome the rough surfaces is applied to the mechanical element 106.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A friction ball joint, comprising:
a clam shell ball formed from at least two segments, having a mechanical element extending from a clam shell segment, wherein an inside surface of the clam shell segment is roughened; and
a ball having a roughened surface inserted between the clam shell segments.

2. The friction ball joint of claim 1, wherein the mechanical element is a shaft.

3. A method of using a friction ball joint, comprising:
attaching a first mechanical element extending from a friction ball joint to an object;
attaching a second mechanical element extending from the friction ball joint to a second object;
positioning the first object in a selected position relative to the second object by moving at least one mechanical element of the friction ball joint; and
maintaining the first object in a selected position using friction.

4. The method of claim 3, wherein the first and second mechanical elements are shafts.

5. An apparatus for positioning, comprising:
means for attaching a first mechanical element extending from a friction ball joint to an object;
means for attaching a second mechanical element extending from the friction ball joint to a second object;
means for positioning the first object in a selected position relative to the second object by moving at least one mechanical element of the friction ball joint; and
means for maintaining the first object in a selected position using friction.
